(19) United States
(12) Patent Application Publication
(10) Pub. No.: US 2012/0249306 A1
(43) Pub. Date: Oct. 4, 2012

(54) RF-ID TAG AND RF-ID COMMUNICATION SYSTEM

(75) Inventor: Nobuyuki Tada, Minami-Ashigara-shi (JP)

(73) Assignee: FUJIFILM CORPORATION, Tokyo (JP)

(21) Appl. No.: 13/435,794

(22) Filed: Mar. 30, 2012

(30) Foreign Application Priority Data
Mar. 31, 2011 (JP) 2011-081056

(51) Int. Cl. G06K 7/01; G06K 19/077

(52) U.S. Cl. 340/10.1; 235/492

(57) ABSTRACT

An RF-ID tag has an IC, a loop antenna to which the IC is connected, and a linear booster antenna, and the booster antenna has, as one end portion in a longitudinal direction of the linear booster antenna, a fold-back portion which is wound; and a portion, having a length that measures 73% or more of a one-turn overall length of a loop of the loop antenna, of the loop antenna extends along a portion, including the fold-back portion, of the booster antenna.

### CROSS-REFERENCE TO RELATED APPLICATIONS

This application claims the benefit of Japanese Patent Application JP 2011-081056, filed Mar. 31, 2011, the entire content of which is hereby incorporated by reference, the same as if set forth at length.

### FIELD OF THE INVENTION

The present invention relates to an RF-ID (radio frequency identification) tag and an RF-ID communication system.

### BACKGROUND OF THE INVENTION

In recent years, non-contact communication devices which receive information from the outside and send information to the outside using electromagnetic waves as a medium have come to be used commonly (refer to JP-A-2006-203852 and JP-A-2009-075687, for example). A non-contact IC label and a non-contact card which are example non-contact communication devices are equipped with an IC chip and a communication antenna that is electrically connected to the IC chip. When the communication antenna receives electromagnetic waves, electromotive force occurs in the communication antenna through resonance. The IC chip is activated by the electromotive force and information stored in the IC chip is converted into a signal. The signal representing the information is transmitted by the communication antenna and receivedby the antenna of a receiver. A controller of the receiver performs data processing such as signal identification.

JP-A-2006-203852 discloses a non-contact IC module which is free of risk the function of a booster antenna is impaired. In this non-contact IC module, an IC chip is disposed at a position (the center of an antenna) where the current density of a dipole structure is highest. JP-A-2009-075687 discloses an RF-ID tag which is increased in the accuracy of communication with an external circuit and the degree of freedom of sticking.

### SUMMARY OF THE INVENTION

Non-contact communication devices as disclosed in JP-A-2006-203852 and JP-A-2009-075687 have a narrow resonance bandwidth because they are designed so as to perform a communication at a particular wavelength. However, since the frequency of transmitted electromagnetic waves depends on the country, it is necessary to prepare communication antennas that are specialized for frequencies used in individual countries. Because of the narrow resonance bandwidth, allowable variation ranges of performance items of components such as an IC chip and antenna members are narrow, which may increase the cost and affect the stability of product operation. Furthermore, the resonance frequency may shift depending on the use situation such as interference between the communication antennas of adjoining RF-ID tags, which may disable a stable communication.

In general, a one-turn loop antenna is connected to an IC chip and a booster antenna is disposed close to the coil of the 1-turn loop antenna in non-contact form. And the 1-turn loop antenna is disposed at the center of the booster antenna. Since the IC chip is disposed close to (for example, mounted on) the 1-turn loop antenna, the IC chip is located approximately at the center of the booster antenna. Therefore, in printing a label on an RF-ID tag, printing on a label central portion is avoided to prevent the IC chip (located in the label central portion) from being damaged. This restriction inevitably lowers the value of label expression.

The present invention has been made in the above circumstances, and a first object of the invention is to provide a configuration for increasing the bandwidth of a communication antenna of an RF-ID tag.

A second object of the invention is to increase the degree of freedom of disposition of an IC chip by making it possible to dispose the IC chip at a position other than the center of a communication antenna.

(1) An RF-ID tag according to the invention comprises an IC, a loop antenna to which the IC is connected, and a linear booster antenna which may be long and narrow as a whole, wherein:

the booster antenna has, as one end portion in its longitudinal direction, a fold-back portion which is wound; and

a portion, having a length that measures 73% or more of a one-turn overall length of a loop of the loop antenna, of the loop antenna extends along a portion, including the fold-back portion, of the booster antenna.

(2) An RF-ID communication system according to the invention comprises:

the RF-ID tag of item (1); and

a reader or a reader/writer which performs a wireless communication with the RF-ID tag.

The RF-ID tag and the RF-ID communication system according to the invention make it possible to provide a configuration for increasing the bandwidth of a communication antenna and thereby contribute to cost reduction and stabilization of product operation. Furthermore, disposing an IC chip at a position other than the center of a communication antenna prevents a disconnection from occurring in a connection portion of the IC chip and an antenna portion and eliminates restrictions relating to label printing to avoid lowering of the value of label expression.

### BRIEF DESCRIPTION OF THE DRAWINGS

FIG. 1 illustrates a dipole antenna and its current distribution.

FIG. 2 shows the configuration of an RF-ID tag which is a combination of a loop antenna and a booster antenna.

FIG. 3A shows a configuration in which a booster antenna has meandering structures extending in its longitudinal direction, and FIG. 3B shows a configuration in which a booster antenna has meandering structures extending in the direction that is perpendicular to its longitudinal direction.

FIG. 4 shows the configuration of an RF-ID tag according to an embodiment of the present invention.

FIG. 5 is an exploded view of part of the RF-ID tag of FIG. 4.

FIG. 6 shows a booster antenna model.

FIG. 7 shows other forms of a fold-back portion of the booster antenna.

FIGS. 8A and 8B show models of booster antennas whose fold-back portions have different physical dimensions.

FIG. 9A is a sectional view schematically showing a state that bending stress is imposed on a smart card in which a loop antenna and an IC chip are disposed at the center, in the longitudinal direction, of a booster antenna, and FIG. 9B is a sectional view schematically showing a state that bending stress is imposed on a smart card incorporating the RF-ID tag shown in FIG. 4.

FIG. 10 shows the configuration of an RF-ID tag according to another embodiment.

FIGS. 11A and 11B show the configurations of RF-ID tags according to other embodiments.

FIG. 12 is a schematic wiring diagram of an RF-ID tag system in which one of the RF-ID tags according to the embodiments is used as an active tag.

FIG. 13 shows an appearance of a recording tape cartridge and a label stuck to it.

FIG. 14 is a schematic diagram showing plural tape cartridges and a library apparatus.

FIGS. 15A and 15B show analysis models having different positional relationships between a loop antenna and a booster antenna; FIG. 15A shows the configuration of a common antenna unit in which a loop antenna is disposed approximately at the center of a booster antenna, and FIG. 15B shows the configuration of an antenna unit in which a loop antenna is disposed at one end of a booster antenna.

FIG. 16 is a graph showing simulation results of the S11 parameter and the VSWR of each of the antenna units shown in FIGS. 15A and 15B.

FIG. 17 shows an analysis model in which the position of a loop antenna is varied one end of a booster antenna to its center.

FIG. 18 is a graph showing simulation results of the analysis model shown in FIG. 17.

FIGS. 19A, 19B and 19C show analysis models in which one end portion of a booster antenna coextends with two sides, three sides, and approximately four sides, respectively, of a loop antenna.

FIG. 20 is a graph showing simulation results of the analysis model shown in FIGS. 19A, 19B and 19C.

FIG. 21 shows an analysis model in which that portion of a loop antenna which coextends with one end portion of a booster antenna is varied between two sides and three sides.

FIG. 22 is a graph showing simulation results of the analysis model shown in FIG. 21.

FIGS. 23A, 23B and 23C show analysis models in which a fold-back portion of a booster antenna has a spiral shape, a two-turn shape in which the inside loop and the outside loop are wound in opposite directions, and a shape in which a wide pad is formed inside a loop, respectively.

FIG. 24 is a graph showing simulation results of the analysis model shown in FIGS. 23A, 23B and 23C.

FIG. 25 shows an analysis model in which the length of a side including a projection, projecting from a loop antenna, of a fold-back portion of a booster antenna is varied.

FIG. 26 is a graph showing simulation results of the analysis model shown in FIG. 25.

FIG. 27A shows simulation results with a condition X=0 mm, and FIG. 27B shows simulation results with a condition X=26 mm.

FIG. 28 shows an analysis model in which the length of a projection, projecting from a loop antenna, of a fold-back portion of a booster antenna is varied.

FIG. 29 is a graph showing simulation results of the analysis model shown in FIG. 28.

FIG. 30A shows simulation results with a condition X=0 mm, and FIG. 30B shows simulation results with a condition X=40 mm.

FIG. 31 shows simulation results of the S11 parameter and the VSWR of each of a one-turn loop antenna itself and a combination of a one-turn loop antenna and a booster antenna.

### DESCRIPTION OF SYMBOLS

13: Antenna portion
15: IC chip
17: Loop antenna
19: Booster antenna
21: Pad
23: IC chip
25, 25A: Loop antenna
27, 27A: Booster antenna (linear booster antenna)
27a: Side
29, 29A: Fold-back portion
31, 32, 33: Side
35: Pad
37: Smart card
41: Receiving circuit
43: Transmitting circuit
51: Recording tape cartridge
65: Label
67: Tag
100, 200, 300, 400: RF-ID tag
600: RF-ID tag system

### DETAILED DESCRIPTION OF THE INVENTION

Embodiments of the present invention will be hereinafter described in detail with reference to the drawings.

First, a basic antenna configuration of an RF-ID tag and restrictions relating to antenna arrangement will be described briefly using a dipole antenna as an example.

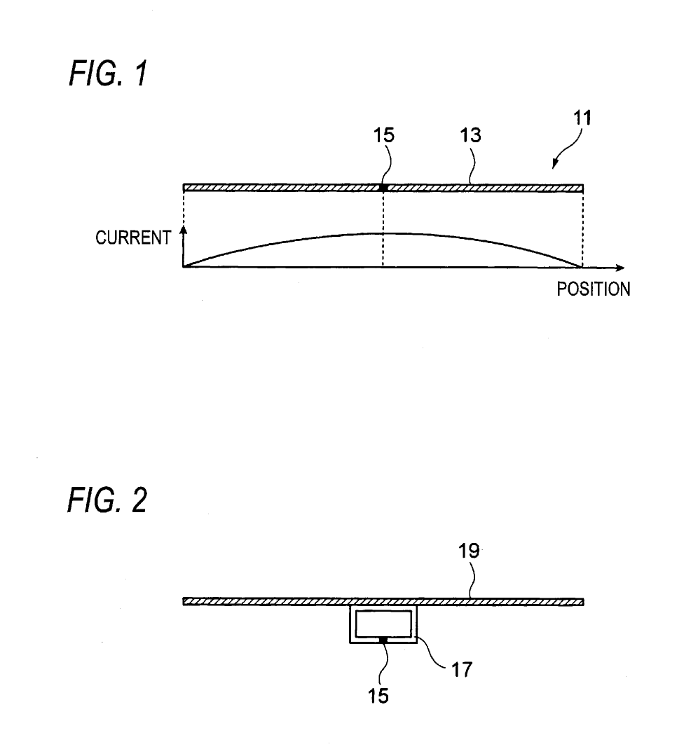

FIG. 1 illustrates a dipole antenna and its current distribution. The dipole antenna 11 has a linear antenna portion 13 and an IC chip 15 which is disposed at the center, in the longitudinal direction, of the antenna portion 13. The dipole antenna 11 has a current density distribution that the current density is low at both ends and high at the center.

Therefore, when an RF-ID (radio frequency identification) tag is constructed by combining a loop antenna 17 and a booster antenna 19 in a manner shown in FIG. 2, maximum performance (maximum gain) is obtained by disposing the loop antenna 17 at the center of the booster antenna 19. However, in this configuration, since the booster antenna 19 is long in its longitudinal direction, the position where the loop antenna 17 is disposed is restricted to the center of the booster antenna 19.

Usually, if the loop antenna 17 is disposed at an end of the booster antenna 19, the magnetic inductive coupling between the loop antenna 17 and the booster antenna 19 is insufficient and hence desired performance cannot be attained.

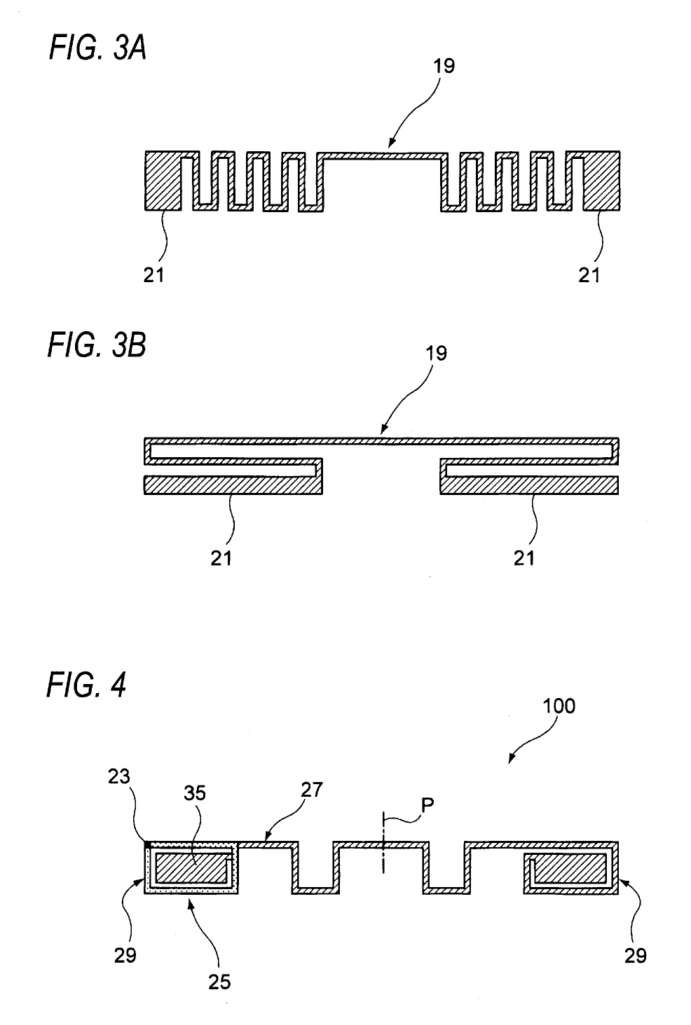

As shown in FIGS. 3A and 3B, the antenna length can be shortened by employing a meandering structure and the antenna length can be shortened further by adding wide pads 21 at both ends of an antenna.

Usually, a dipole antenna etc. are designed taking into consideration impedance matching in a frequency band used. However, in the case of UHF RF-ID tag antennas, it is desired that their bandwidth be made as wide as possible because it is expected that they will be used being stuck to things made of various materials such as paper, plastics, and wood and hence they need to be designed so as to accommodate variations of permittivity values of these materials.

The reflection coefficient S11 parameter (reflection coefficient) and the VSWR (voltage standing wave ratio) are effective indices to be used for judging the level of bandwidth elongation. It is desirable that a dipole antenna or the like be designed so that the frequency range in which the S11 parameter is smaller than or equal to −3 dB or the VSWR is smaller than or equal to 6 (in general, smaller than or equal to 2) is wide.

### <First Example Configuration>

FIG. 4 shows the configuration of an RF-ID tag according to an embodiment of the invention. The RF-ID tag 100 is equipped with an IC chip 23, a loop antenna 25 to which the IC chip 23 is connected, and a linear booster antenna (hereinafter referred to as a booster antenna) 27 which is long and narrow over its entire length.

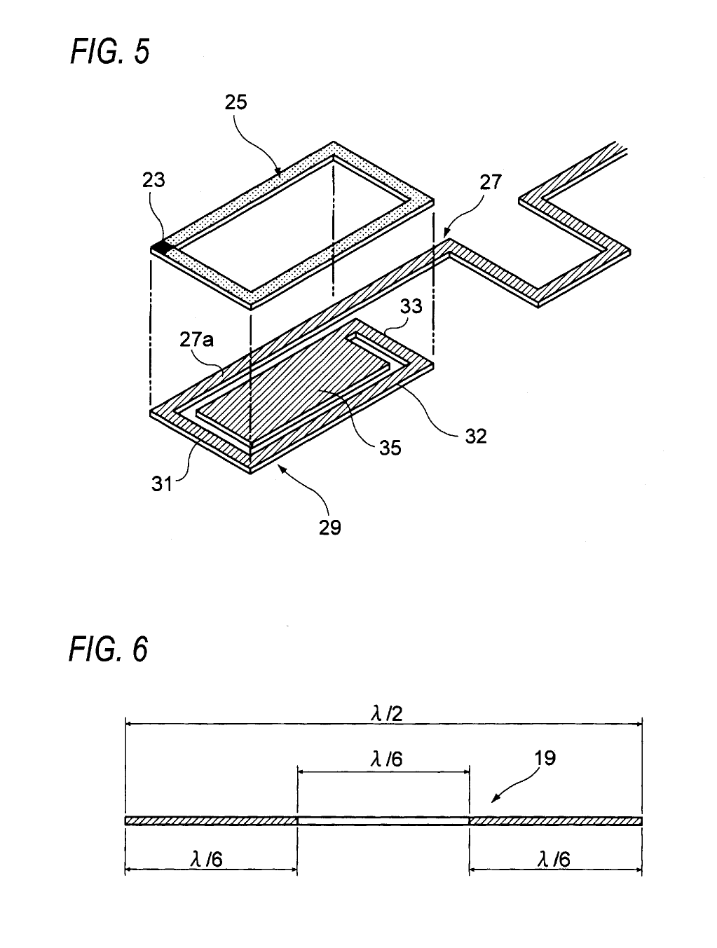

FIG. 5 is an exploded view of part of the RF-ID tag 100. As shown in FIG. 5, the loop antenna 25 and the booster antenna 27 are formed separately and placed close to each other in non-contact form with a dielectric layer (not shown) interposed in between. Examples of the dielectric layer are an air layer, an adhesive layer, a printed circuit board, a plastic member made of polycarbonate or the like, and a ceramic member. It is preferable that the interval, in the thickness direction, between the loop antenna 25 and the booster antenna 27 be shorter than or equal to 2 mm.

The loop antenna 25 is a rectangular-loop-shaped conductor, and the IC chip 23 is connected to (in electrical contact with) part of it. The loop antenna 25 is designed so as to have an optimum shape and size using its reflection coefficient S11, VSWR, and reverse transmission coefficient S12 as indices so as to resonate in a UHF band around 900 MHz (850 MHz to 1 GHz). Alternatively, the loop antenna 25 may have a circular or polygonal shape.

In FIG. 5, the IC chip 23 is located at a corner of the loop antenna 25 over one end, in the longitudinal direction, of the booster antenna 27. However, the IC chip 23 may be located at any position in the loop antenna 25 and hence may be located, for example, on a side or at a corner.

The booster antenna 27 has, as each end portion in its longitudinal direction, a fold-back portion 29. Each fold-back portion 29 is wound in rectangular form and consists of a side 27a which extends in the same direction as the longitudinal direction of the booster antenna 27 to the end in the longitudinal direction and three sides 31-33 which are wound from the end of the side 27a (the side 31 is located at the end in the longitudinal direction of the booster antenna 27). One fold-back portion 29 extends along the loop antenna 25. In the embodiment, the sides of the loop antenna 25 coextend with at least three sides of the one fold-back portion 29 of the booster antenna 27.

In the example configuration of FIG. 4, approximately the four wound sides 27a and 31-33 of the one fold-back portion 29 of the booster antenna 27 coextend with the sides of the loop antenna 25. Alternatively, the sides 27a and 31-33 of one fold-back portion 29 of the booster antenna 27 may extend close to the sides of the loop antenna 25. The fold-back portion 29 of the booster antenna 27 may be wound in circular or polygonal form so as to conform to the shape of the loop antenna 25.

The overlap length should be greater than or equal to 73% (about ¾) of the entire one-turn length of the loop antenna 25. Where the one-turn loop of the loop antenna 25 is circular, the overlap region is an arc region having a central angle 263°. Where the one-turn loop of the loop antenna 25 is square, the overlap region approximately corresponds to three sides.

The booster antenna 27 is line-symmetrical with respect to a line P which passes through its center in its longitudinal direction and perpendicular to it. A pad 35 which is part of the fold-back portion 29 of the booster antenna 27 is disposed inside the loop of the loop antenna 25.

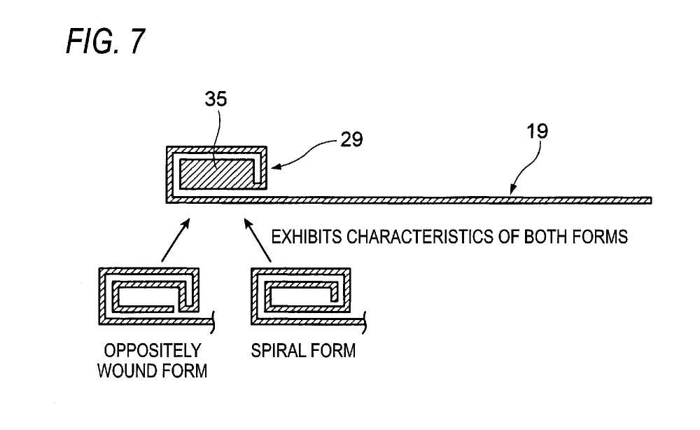

As shown in the bottom part of FIG. 7, where the fold-back portion 29 of a booster antenna 19 is of two turns, the booster antenna 19 exhibits somewhat different frequency characteristics when the fold-back portion 29 has a spiral form in which the inside loop is wound in the same direction as the outside loop and when the fold-back portion 29 has an oppositely wound form in which the winding direction of the inside loop is opposite to that of the outside loop. If the inside loop is replaced by a pad 35 having a pad surface, the booster antenna 19 is given a frequency characteristic that exhibits the frequency characteristics of both of the spiral form and the oppositely wound form. Whereas the fold-back portion 29 may be in either of the spiral form and the oppositely wound form, it is preferable that a loop-shaped pattern be formed around the outer circumference of a pad 35.

The booster antenna 27 may be made of any material having high conductivity, and may be formed by any of various forming methods such as a method of sticking, to a subject item, a metal sheet that has been worked into an antenna shape, evaporation or sputtering onto a subject item, printing using a conductive ink, and direct formation by etching.

Although in the embodiment each of the loop antenna 25 and the booster antenna 27 is designed so as to resonate in a UHF band (850 MHz to 1 GHz), in the invention the resonance band is not limited to it.

FIG. 6 shows a booster antenna model. As shown in FIG. 6, a linear booster antenna 19 has a length that is a half of a wavelength λ used. Therefore, in the embodiment, the above-described generally loop-shaped fold-back portion 29 to be electromagnetically coupled with the loop antenna 25 is disposed at one end, in the longitudinal direction, of the booster antenna 27. It is appropriate to dispose the fold-back portion 29 in a λ/6 region (extending from the end) of the booster antenna 27. In other words, a loop to be electromagnetically coupled with the loop antenna 25 is formed in either of the end regions excluding the central λ/6 region.

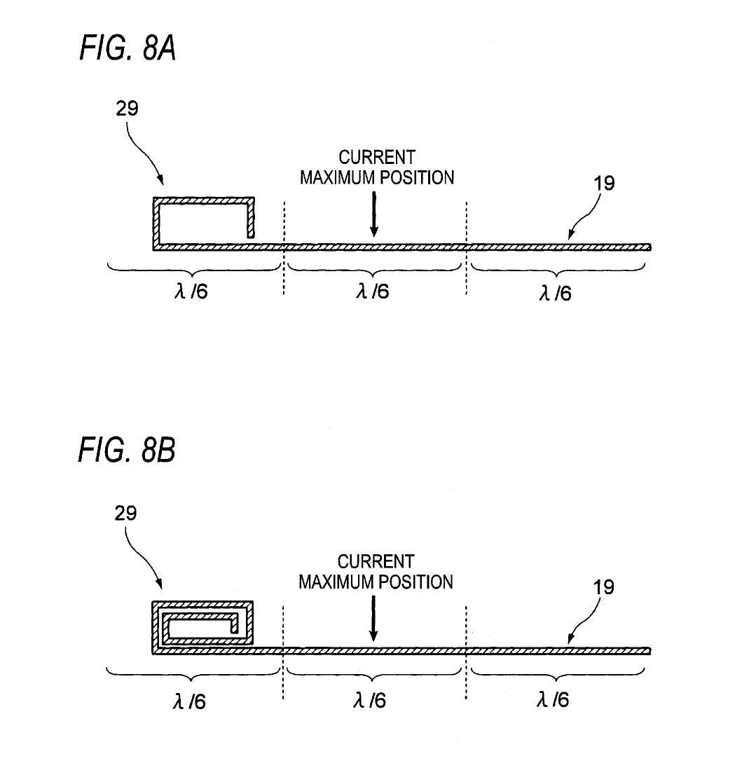

The term “wavelength λ” as used above is a wavelength as converted using a current distribution and is not a physical dimension. FIGS. 8A and 8B show models of the fold-back portion 29. As shown in FIGS. 8A and 8B, although the two booster antennas 19 have different total physical antenna lengths, both of them measure λ/2 in terms of a current distribution. Current distribution differences occur only in the left-hand λ/6 region of the booster antennas 19. Therefore, the two booster antenna 19 have approximately the same antenna center position in terms of a current distribution (i.e., the antenna center position is not affected by the loop length of the fold-back portion 29).

In the RF-ID tag 100 shown in FIG. 4, the loop antenna 25 is intentionally disposed at one end, in the longitudinal direction, of the booster antenna 27 where the current is small rather than at the center where the current is large and approximately the four sides of the loop antenna 25 are thereby coupled with the booster antenna 27 electromagnetically, whereby the communication-possible frequency band can be made wider while the communication sensitivity is kept sufficiently high. This makes it possible to use a single RF-ID tag to cover different frequencies used in individual countries. The increase in antenna bandwidth contributes to cost reduction and stabilization of product operation because allowable variation ranges of performance items of the IC chip 23, antenna members, etc. are increased. Furthermore, the allowable range of resonance frequency variations that are caused by permittivity differences between goods havingRF-ID tags, interference between the antennas of many adjoining RF-ID tags, and environments (e.g., water contained in human bodies) of RF-ID tags.

The resonance frequency can be adjusted by forming meandering lines in portions of the booster antenna 27 excluding the portion that overlaps with the loop antenna 25.

Since the IC chip 23 which is connected to the loop antenna 25 is disposed in the region that is not located at the center of the booster antenna 27, occurrence of a disconnection in the connection portion of the IC chip 23 and the loop antenna 25 can be prevented when the RF-ID tag 100 is incorporated in a smart card. The disconnection preventing effect is enhanced by disposing the IC chip 23 at a position that is as close to the end, in the longitudinal direction, of the RF-ID tag 100 as possible.

The smart card is a card such as a battery-less (i.e., no power source (battery) is provided) IC card, magnetic card, optical card, or a combination thereof which complies with ISO 7810, as typified by a smart cart incorporating a microprocessor and a memory. The smart card may also be a plastic card for an identification purpose only and like ones.

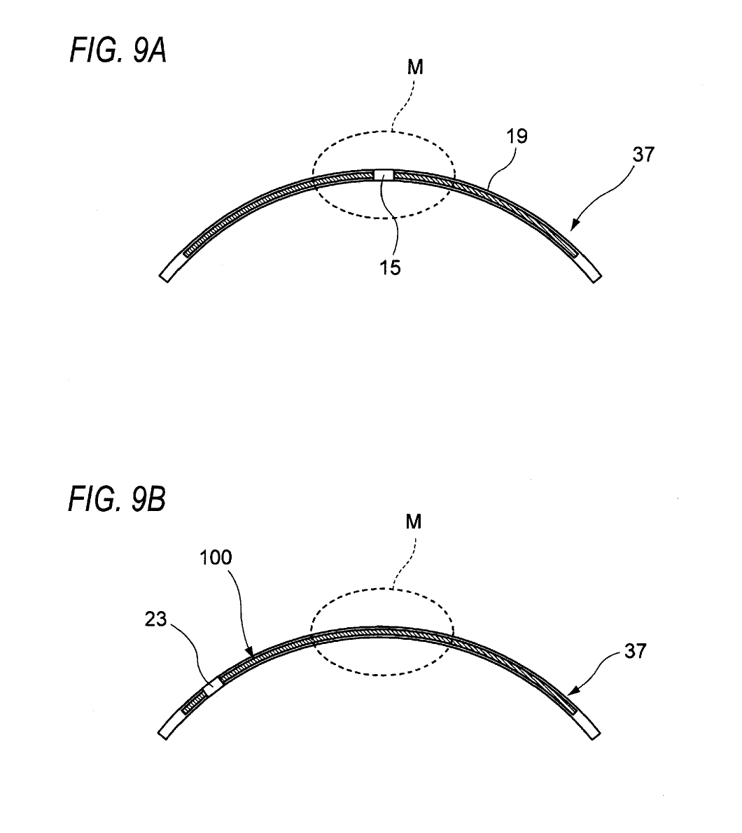

FIG. 9A is a sectional view schematically showing a state that bending stress is imposed on a smart card 37 in which a loop antenna and an IC chip 15 are disposed at the center, in the longitudinal direction, of a booster antenna 19. In this case, since the connection portion of the IC chip 15 and the loop antenna is located in a region M where the bending stress is concentrated, a disconnection tends to be induced in the connection portion.

FIG. 9B is a sectional view schematically showing a state that bending stress is imposed on a smart card 37 incorporating the RF-ID tag 100 shown in FIG. 4. In this case, since the IC chip 23 is not located in a region M where the bending stress is concentrated, the risk of occurrence of a disconnection in the connection portion of the IC chip 23 and the loop antenna 25 can be lowered.

In the case of FIG. 9A in which the loop antenna and the IC chip 15 are disposed at the center of the booster antenna 19, in forming a label using the RF-ID tag, printing etc. on a label central portion needs to be avoided to prevent the IC chip 15 which is located there from being damaged. This restriction inevitably lowers the value of label expression.

On the other hand, in the case of FIG. 9B in which the loop antenna 25 and the IC chip 23 are disposed at one end of the booster antenna 27, the IC chip 23 can be disposed at a label corner portion, as a result of which no restriction is imposed on label printing and the value of label expression is not lowered.

In conventional, commonly employed antennas which are not designed so as to increase the bandwidth sufficiently, they are used in limited environments or countermeasures against influence of nearby objects (e.g., electronic components in general, water, a human body, and metal members) are taken such as addition of a radio wave absorbing sheet and formation of an ample internal space for reduction of influence. The RF-ID tag 100 shown in FIG. 4 makes it possible to relax such restrictions relating to the design.

### <Second Example Configuration>

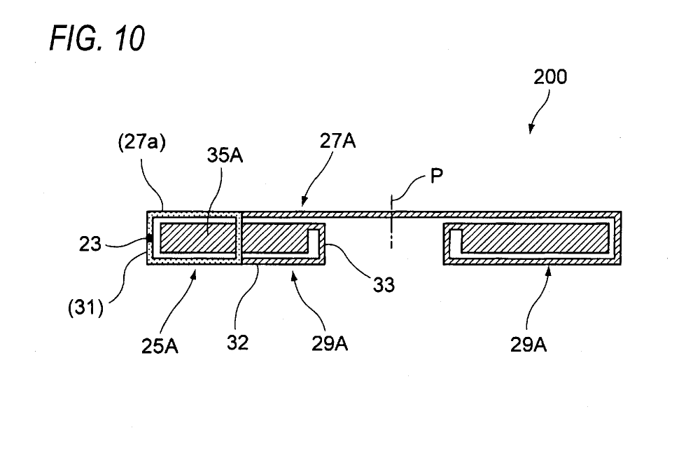

Next, an RF-ID tag according to another embodiment will be described. FIG. 10 shows the configuration of an RF-ID tag according to another embodiment. In this RF-ID tag 200, as in the RF-ID tag 100 shown in FIG. 4, a fold-back portion 29A is formed at both ends, in the longitudinal direction, of a booster antenna 27A and a loop antenna 25A is laid on one fold-back portion 29A so as to overlap with the latter. That is, a side 27a, a side 31, and part of a side 32 of the booster antenna 27A extend under (as viewed in FIG. 10) the loop antenna 25A with a dielectric layer interposed in between.

Each fold-back portion 29A of the booster antenna 27A is longer in the longitudinal direction than each fold-back portion 29 shown in FIG. 4. More specifically, the side 32 and a pad 35A of each fold-back portion 29A is about two times as long as the side 32 and the pad 35 of each fold-back portion 29 shown in FIG. 4. The portion other than the fold-back portions 29A of the booster antenna 27A is straight, and the entire booster antenna 27A is line-symmetrical with respect to a center line P. By elongating each fold-back portion 29A, the resonance frequency can be decreased without increasing the width of the entire booster antenna 27A.

The loop antenna 25A has the same size as the loop antenna 25 shown in FIG. 4, and an IC chip 23 is disposed on the loop antenna 25A at a position that is right over the center of the side 31 (located at the end in the longitudinal direction) of the booster antenna 27A.

According to the RF-ID tag 200 of this embodiment, the antenna characteristics are improved by disposing the loop antenna 25A over the end-side half of the fold-back portion 29A which is longer than the loop antenna 25A.

### <Third Example Configuration>

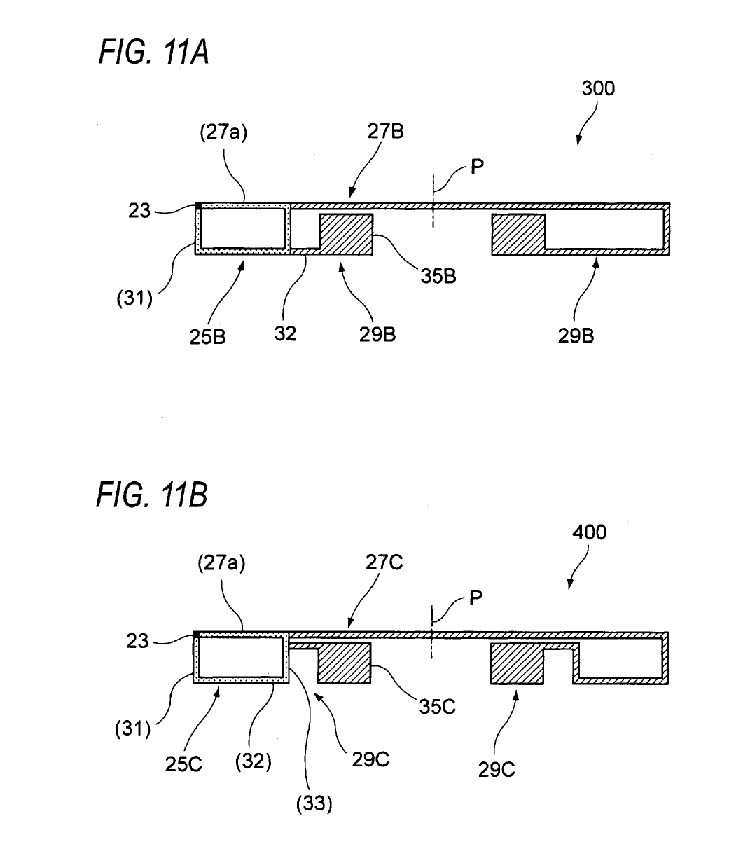

FIG. 11A shows an RF-ID tag according to still another embodiment. In the RF-ID tag 300 shown in FIG. 11A, three sides of a loop antenna 25B are electromagnetically coupled with a side 27a, a side 31, and part of a side 32 of a booster antenna 27B and an IC chip 23 is disposed on the loop antenna 25B at a position that is right over a corner of the side 31 (located at the end in the longitudinal direction) of the booster antenna 27B.

According to the RF-ID tag 300 of this embodiment, the resonance frequency can be decreased without increasing the width of the entire booster antenna 27B because a pad 35B of the booster antenna 27B is disposed at such a position as not to be surrounded by the sides 27a, 31, and 32.

### <Fourth Example Configuration>

FIG. 11B shows an RF-ID tag according to yet another embodiment. In the RF-ID tag 400 shown in FIG. 11B, approximately four sides of a loop antenna 25C are electromagnetically coupled with sides 27a and 31-33 of a booster antenna 27C and an IC chip 23 is disposed on the loop antenna 25C at a position that is right over a corner of the side 31 (located at the end in the longitudinal direction) of the booster antenna 27C.

According to the RF-ID tag 400 of this embodiment, the resonance frequency can be decreased without increasing the width of the entire booster antenna 27C because a pad 35C of the booster antenna 27C is disposed at such a position as not to be surrounded by the sides 27a and 31-33.

### <Fifth Example Configuration>

Each of the RF-ID tags 100, 200, 300, and 400 according to the above embodiments can be used as not only a passive tag but also an active tag. The above-described advantages can also be obtained when each of the antenna configurations according to the above embodiments is applied to the antenna of a radio-type reader or a reader/writer.

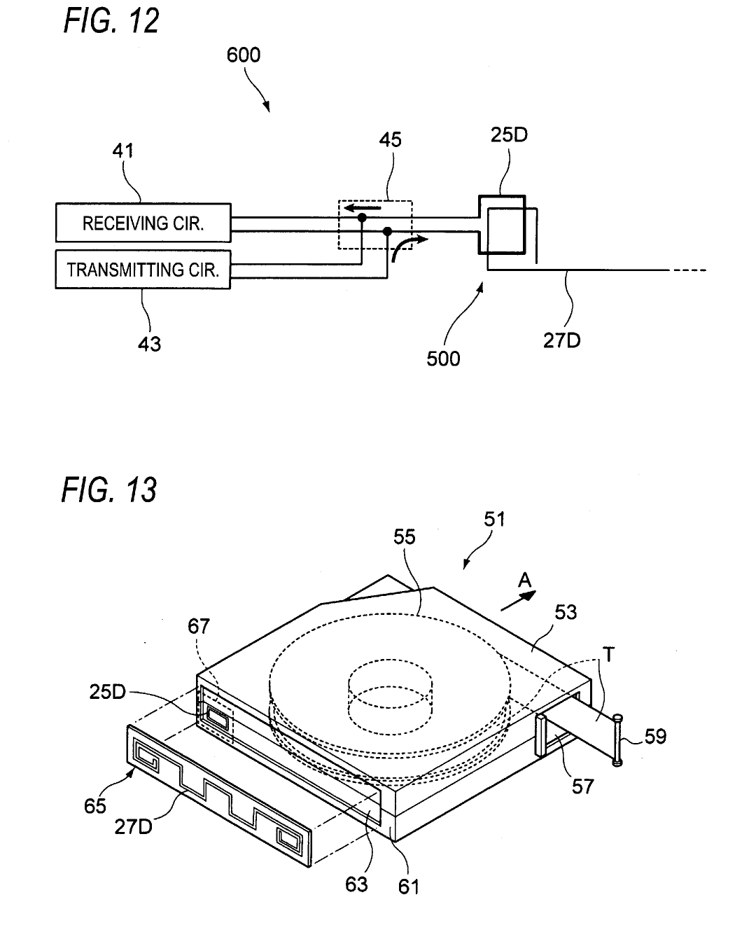

FIG. 12 shows the configuration of an RF-ID tag system in which one of the RF-ID tags 100, 200, 300, and 400 according to the above embodiments is used as an active tag. FIG. 12 is a schematic wiring diagram of the RF-ID tag system.

The RF-ID tag system 600 is equipped with an RF-ID tag antenna unit 500, a receiving circuit 41 and a transmitting circuit 43 which are connected to the RF-ID tag antenna unit 500, and a coupler 45 which splits a pair of signal lines coming from the RF-ID tag antenna unit 500 into two pairs of signal lines connected to the receiving circuit 41 and the transmitting circuit 43, respectively.

The RF-ID tag antenna unit 500 has a loop antenna 25D and a booster antenna 27D, and the loop antenna 25D is connected to the receiving circuit 41 and the transmitting circuit 43 via the coupler 45. That is, in this embodiment, the IC chip is replaced by the active tag communication system.

As is understood from the above description, each of the RF-ID tags 100, 200, 300, and 400 according to the embodiments can be applied to radio communication apparatus in general. More specifically, the following steps are taken. (1) A substrate with a loop antenna having a one-turn loop structure is manufactured and incorporated in an apparatus. (2) On the apparatus side, a booster antenna is disposed so as to have one of the above-describedpositional relationships with the one-turn loop antenna and to establish matching between them. In this case, the degree of freedom of the loop antenna position can be increased.

### Example 1

In a multilayer substrate, two layers having an arbitrary interval is provided as a loop antenna forming layer and a booster antenna forming layer. Which layers a loop antenna and a booster antenna should be formed in is determined as appropriate taking into consideration the thickness of each layer of the substrate, the permittivity of the substrate, and the antenna shapes.

### Example 2

A loop antenna is formed on a substrate which includes a power source for an active tag. A booster antenna is disposed on the inner surface or the outer surface of an apparatus case which houses the substrate, so as have a particular positional relationship with a loop antenna.

Where as in the above examples the loop antenna and the booster antenna are separate from and not in contact with each other and have no wiring line connecting them, the booster antenna can be attached and removed when necessary according to a use and whether to permit long-distance communication (security function) or a like item can be set. In these examples, the one-turn loop antenna alone functions as a magnetic induction type tag.

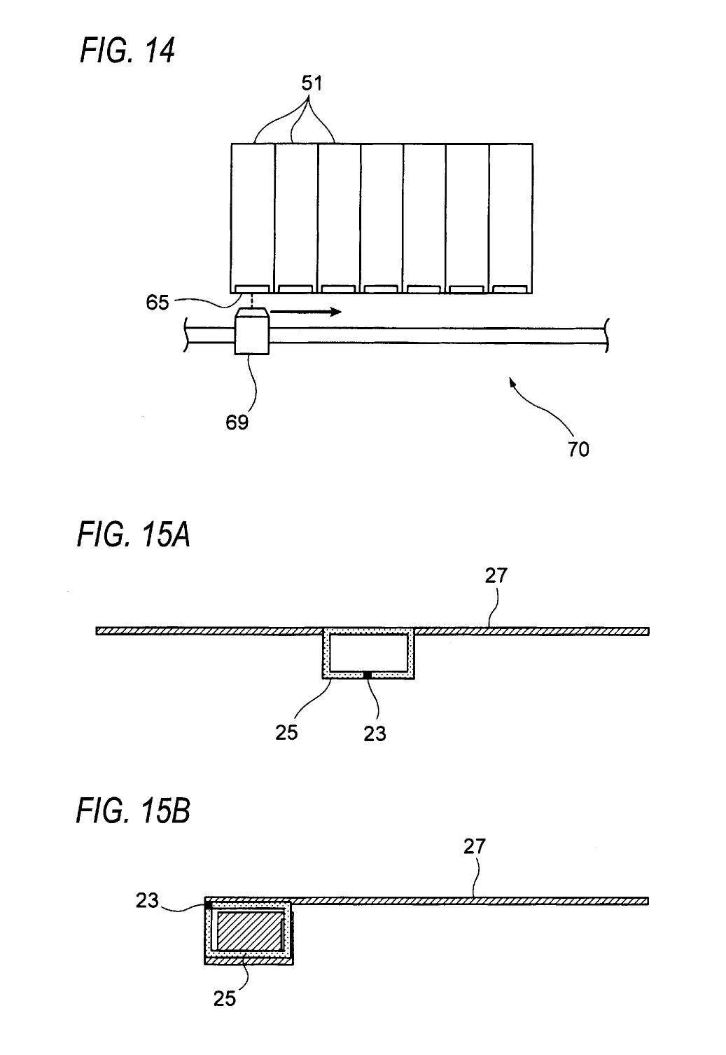

Specific apparatus corresponding to the above Example 1 will be described below with reference to FIGS. 13 and 14.

FIG. 13 shows a recording tape cartridge 51 in which a magnetic tape T as an information recording medium is wound on a single reel 55 which is housed rotatably in a flat case 53. When the recording tape cartridge 51 is loaded into a drive apparatus (not shown) in the direction indicated by arrow A, a window 57 which is located in a headportion in the loading direction is opened and a leader member 59 which is provided at the head of the magnetic tape T is drawn out through the window 57 by the drive apparatus. The magnetic tape T is guided along a prescribed tape path in the drive apparatus and information is written to or read from the magnetic tape T.

A label 65 is stuck to a label area in a recess of a back surface 61 (located on the origin side of arrow A) of the flat case 53 of the recording tape cartridge 51. While not in use, the recording tape cartridge 51 is stored in a library apparatus with such orientation that the label 65 which is stuck to the label area 63 can be seen. Information represented by characters, symbols, etc. that can be seen by a user is printed or hand-written on the label 65.

An active or passive tag 67 including the receiving circuit 41, the transmitting circuit 43, the coupler 45, and the loop antenna 25D which are shown in FIG. 12 is provided in the recording tape cartridge 51 at a position that is close to the label area 63. On the other hand, the booster antenna 27D shown in FIG. 12 is formed in the label 65. When the label 65 is stuck to the label area 63, as described above the prescribed portion of the booster antenna 27D overlaps with the loop antenna 25D with the wall of the case of the recording tape cartridge 51 interposed in between.

Information that was represented before by a bar code in the case of a bar code label, for example, information for unified management of the individual cartridge 51 while it is stored or is being conveyedby an autoloader, and other information are stored in the receiving circuit 41 and the transmitting circuit 43 of the tag 67 or a storage unit (not shown) connected to them.

To use many recording tape cartridges 51 as backup cartridges or the like, a library apparatus is used which includes a holder for storing many recording tape cartridges 51 and an autoloader for automatically loading and removing a recording tape cartridge 51 into and from a drive apparatus. As shown in FIG. 14, plural recording tape cartridges 51 are arranged at regular intervals in their thickness direction in a holder of a library apparatus 70 with such orientation that their labels 65 can be seen.

A movable head 69 having a reader or a reader/writer is provided in the library apparatus 70 so as to be moved by a transport mechanism facing the labels 65 of the respective recording tape cartridges 51 which are arranged in the holder. In the library apparatus 70, while being moved in the arrangement direction of the recording tape cartridges 51, the movable head 69 reads or writes information by performing a short-distance wireless (non-contact) communication with the booster antenna 27D and the loop antenna 25D of each recording tape cartridge 51 through a reader antenna or a reader/writer antenna as a communication antenna.

According to the RF-ID tag system 600 shown in FIG. 12, the tag 67 can be disposed in a corner portion of the recording tape cartridge 51, whereby a dead space can be utilized effectively and hence the efficiency of space utilization of the recording tape cartridge 51 can be made high.

Since the tag 67 does not require printing, it is not necessary to provide, for example, a structure for preventing the IC chip from being damaged at the time of printing. Since the label 65 is provided with only the booster antenna 27D, there are no restrictions relating to label printing and hence the value of label expression is not lowered. Since the dielectric layer which is the wall, interposed between the loop antenna 25D and the booster antenna 27D, of the case of the recording tape cartridge 51 can be as thick as about several millimeters, the degree of freedom of disposition of the loop antenna 25D and the booster antenna 27D is increased in the case where the loop antenna 25D is disposed inside the recording tape cartridge 51.

According to this embodiment, since no wiring line exists between the loop antenna 25D and the booster antenna 27D, no such failure as a disconnection or a contact failure is induced. In disassembling work of the recording tape cartridge 51, it is not necessary to conduct such appurtenant work as removal of screws or connector wires between the antennas.

Therefore, according to this embodiment, whereas the advantages of bandwidth increase are obtained, the risk of failure is lowered and the number of components and the cost of working can be decreased. The increase of a bandwidth used makes it possible to greatly relax the restrictions relating to the use conditions/environment of an RF-ID tag. For example, margins against influence of the permittivity of water contained in a sticking subject item (made of metal or plastics), a human body, or the like, interference between adjoining RF-ID tags, and other phenomena, whereby the quality of communication is made less prone to disturbances of a human body etc. Furthermore, this embodiment is advantageous when applied to tags with a wideband specification (worldwide specification).

### <Simulation Results>

Next, a description will be made of simulation results of the antenna characteristics of the RF-ID tags according to the embodiments.

### (Analysis 1: Dependence on Arrangement of Loop Antenna and Booster Antenna)

FIGS. 15A and 15B show analysis models having different positional relationships between a loop antenna 25 and a booster antenna 27. More specifically, FIG. 15A shows the configuration of a common antenna unit in which a loop antenna 25 is disposed approximately at the center of a booster antenna 27. FIG. 15B shows the configuration of an antenna unit in which a loop antenna 25 is disposed at one end of a booster antenna 27.

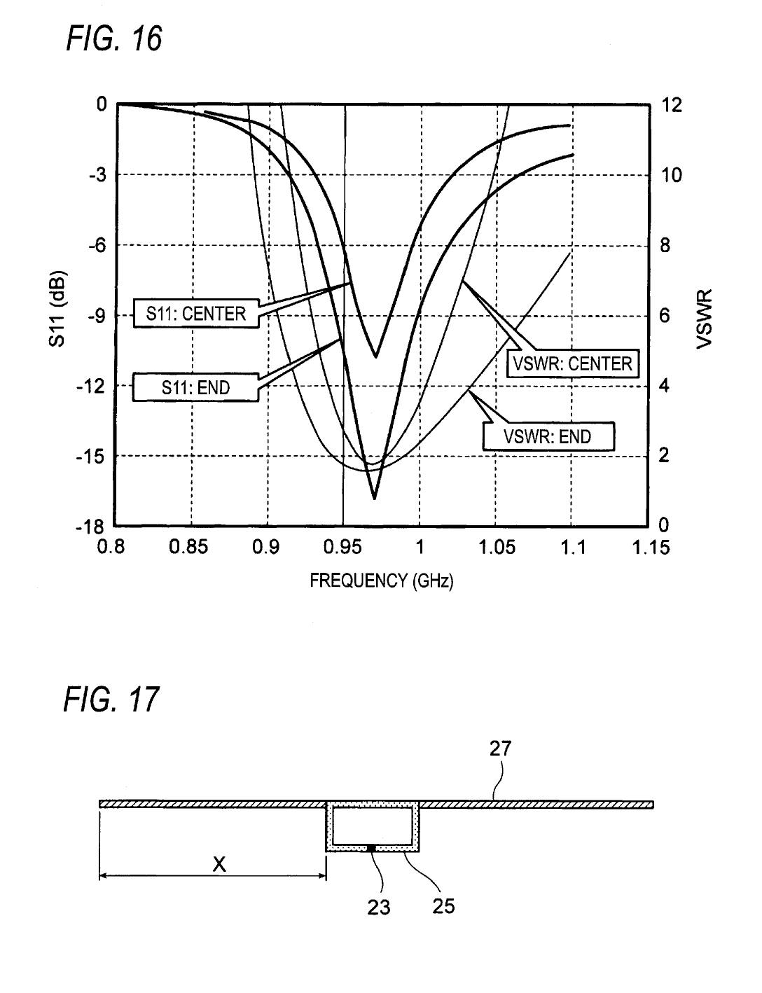

FIG. 16 is a graph showing simulation results of the S11 parameter and the VSWR of each of the antenna units shown in FIGS. 15A and 15B. In FIG. 16, the left-hand vertical axis represents the S11 parameter, the right-hand vertical axis represents the VSWR, and the horizontal axis represents the frequency.

In the models used in the simulation being discussed and simulations to be described later, a one-turn loop antenna 25 and a booster antenna 27 are formed on the respective surfaces of a 1-mm-thick dielectric layer made of a material having a permittivity 2.6. The loop antenna 25 has external dimensions 7.5 mm×14 mm and a pattern width 1 mm. The booster antenna 27 has a basic pattern width 1 mm and its overall length is adjusted so that it has a resonance frequency 960 MHz.

As seen from FIG. 16, the minimum value of the S11 parameter of the antenna unit of FIG. 15B in which a spiral fold-back portion is formed at one end of the booster antenna and the loop antenna 25 is laid on the fold-back portion is smaller than that of the antenna unit of FIG. 15A. And the resonance bandwidths of the S11 parameter and the VSWR of the antenna unit of FIG. 15B are wider than those of the antenna unit of FIG. 15A.

### (Analysis 2: Dependence on Position of One-Turn Loop Antenna in Linear Booster Antenna)

FIG. 17 shows an analysis model in which the position of a loop antenna 25 is varied one end of a booster antenna 27 to its center.

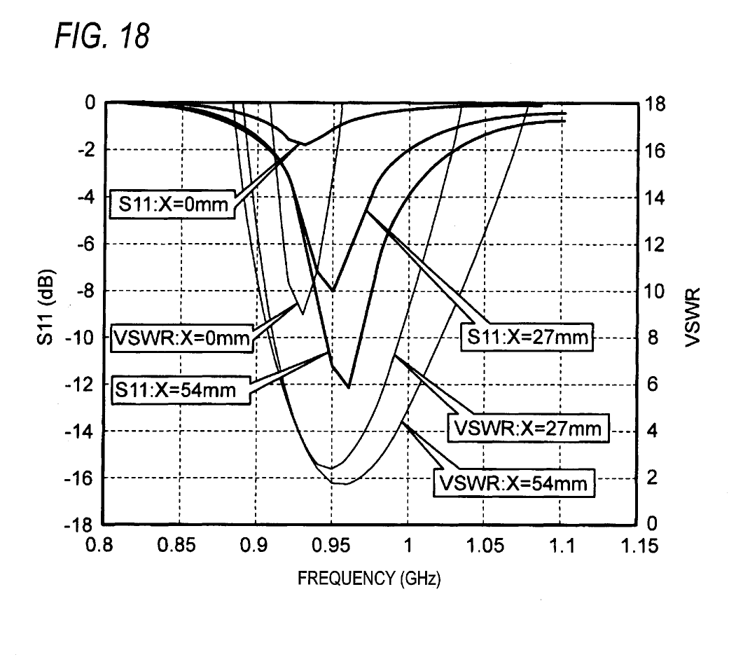

FIG. 18 shows analysis results. As the distance X decreases, that is, as the loop antenna 25 is moved from the center of the booster antenna 27 to its end, the minimum value of the S11 parameter is increased and the resonance bandwidths of the S11 parameter and the VSWR are reduced. The bandwidth reduction of each of the S11 parameter and the VSWR is remarkable on the high frequency side. These analysis results coincide with descriptions that are made in JP-A-2006-203852 and JP-A-2009-075687 as conditions for minimizing the S11 parameter.

### (Analysis 3: Dependence on Shape of Overlap Between One-Turn Loop Antenna and End Portion of Booster Antenna)

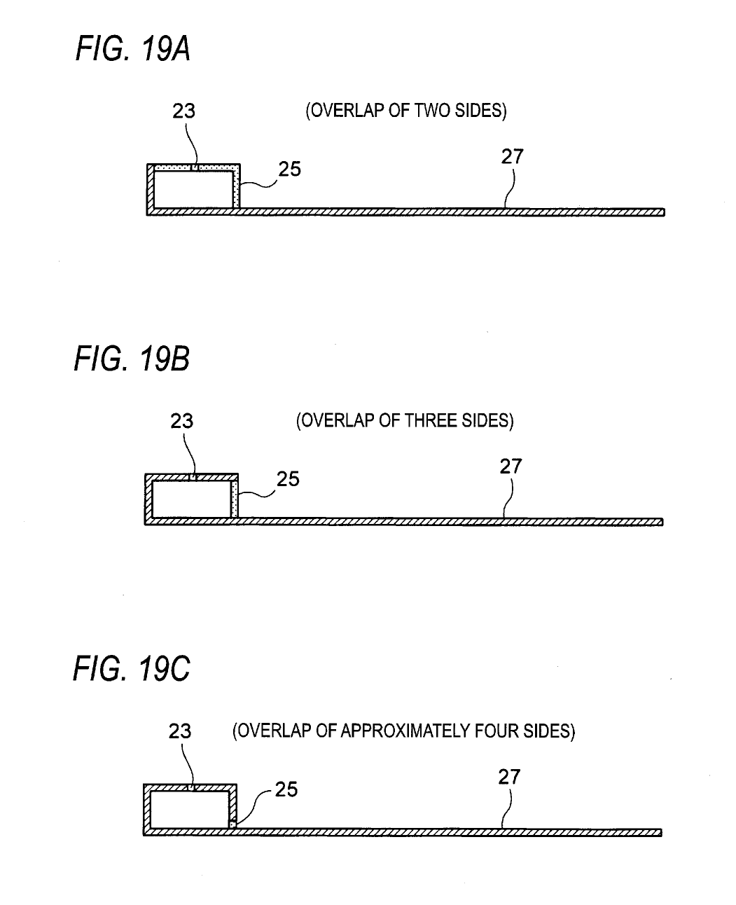

FIGS. 19A-19C show analysis models in which one end portion of a booster antenna 27 coextends with two sides, three sides, and four sides, respectively, of a loop antenna 25.

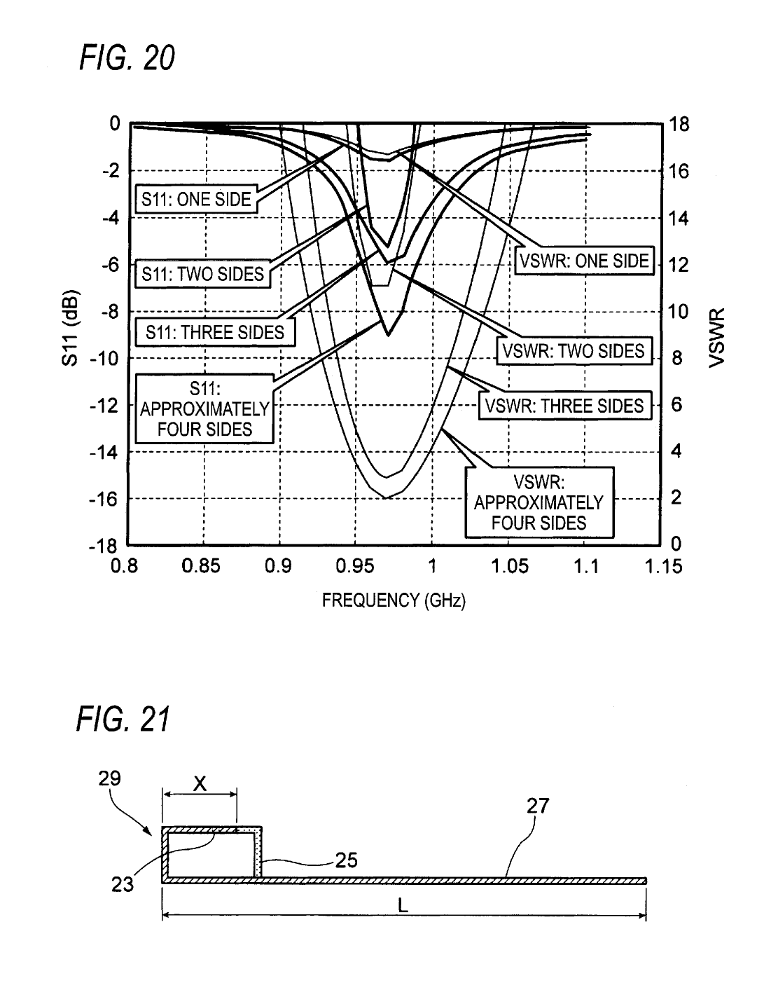

FIG. 20 shows analysis results. As the area of overlap between the one end portion of the booster antenna 27 and the loop antenna 25 increases, the minimum value of the S11 parameter is made smaller and the resonance bandwidths of the S11 parameter and the VSWR are increased.

FIG. 21 shows an analysis model in which that portion of a loop antenna 25 which coextends with one end portion of a booster antenna 27 is varied between two sides and three sides. The entire overlap length is equal to the overlap length of the two sides plus a distance X.

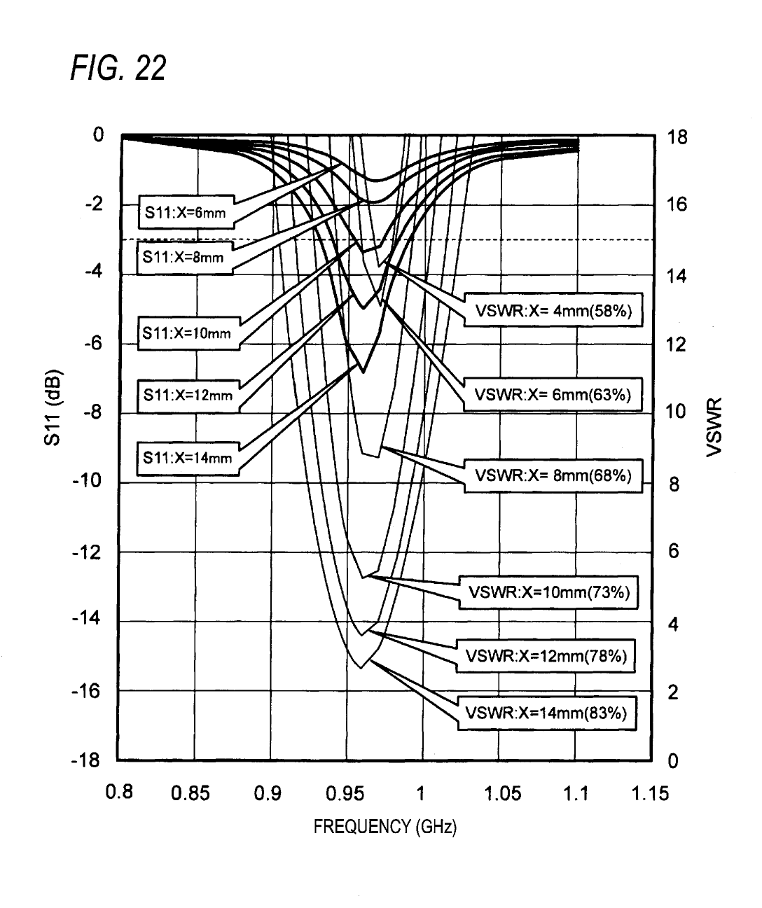

FIG. 22 shows simulation results. In FIG. 22, proportions of overlaps with the one end portion of the booster antenna 27 are also shown in percentage with respect to the overall length C (100%) of the one-turn loop antenna 25. It is seen from FIG. 22 that it is preferable that the overlap length be greater than or equal to 73% of the overall length C of the one-turn loop antenna 25 (X=10 mm) because in that range the S11 parameter is smaller than −3 dB and the VSWR is smaller than 6.

### (Analysis 4: Dependence on Shape of Fold-Back Portion of Booster Antenna)

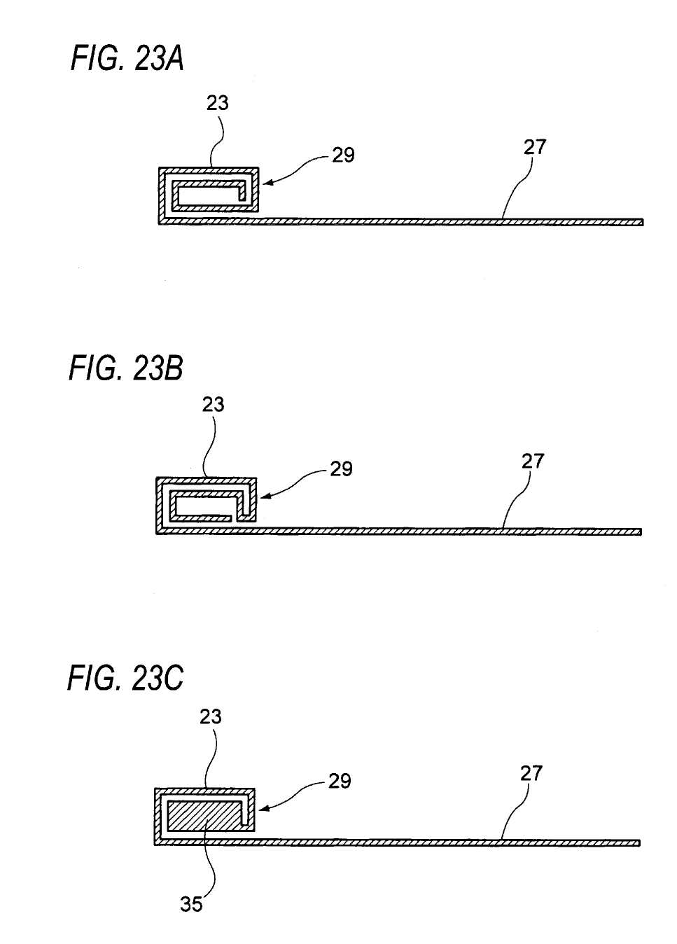

FIGS. 23A-23C show analysis models in which a fold-back portion 29 of a booster antenna 27 has a spiral shape of approximately two turns, a loop shape of approximately two turns in which the inside loop and the outside loop are wound in opposite directions, and a shape in which a wide pad 35 is formed inside a loop, respectively.

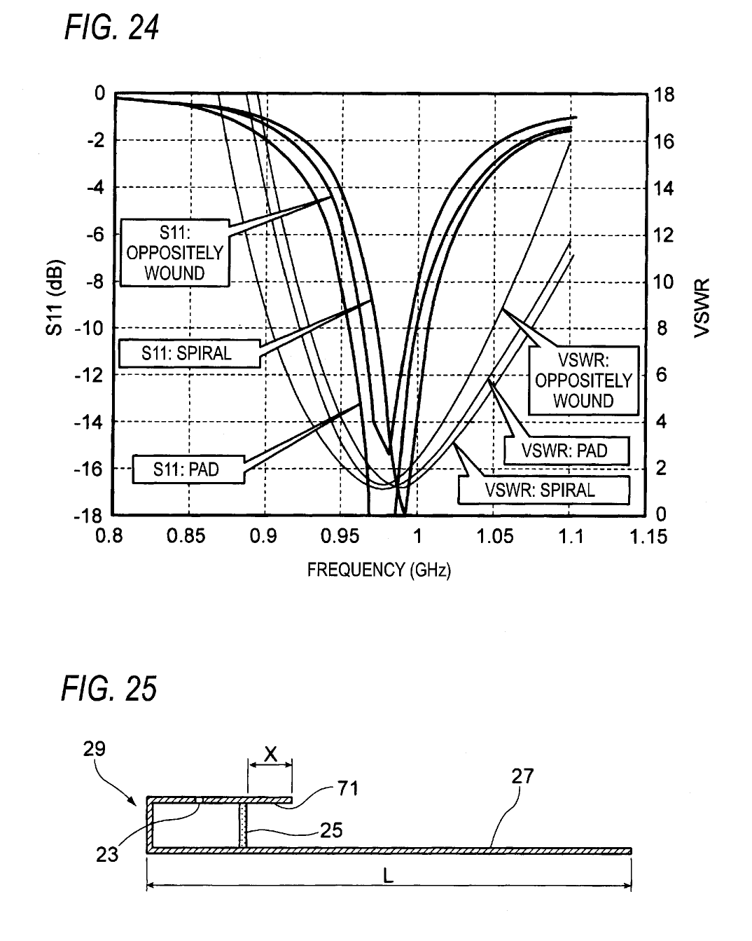

FIG. 24 shows analysis results. The minimum value of the S11 parameter is decreased and the resonance bandwidth of the S11 parameter is increased in order of the oppositely wound shape, the spiral shape, and the pad-inclusive shape (the shape of the fold-back portion 29). The resonance bandwidth of the VSWR is also increased in the same order.

(Analysis 5: Dependence on Shape of End Portion, Coextending with Three Sides of One-Turn Loop Antenna, of Booster Antenna)

FIG. 25 shows an analysis model in which the length of a side including a projection 71, projecting from a loop antenna 25, of a fold-back portion 29 of a booster antenna 27 is varied. In this analysis, the overall length L, in the longitudinal direction, of the booster antenna 27 was set in a range of 105 mm to 108 mm and the length X of the projection 71 was set at 0 mm, 6 mm, 26 mm, and 36 mm.

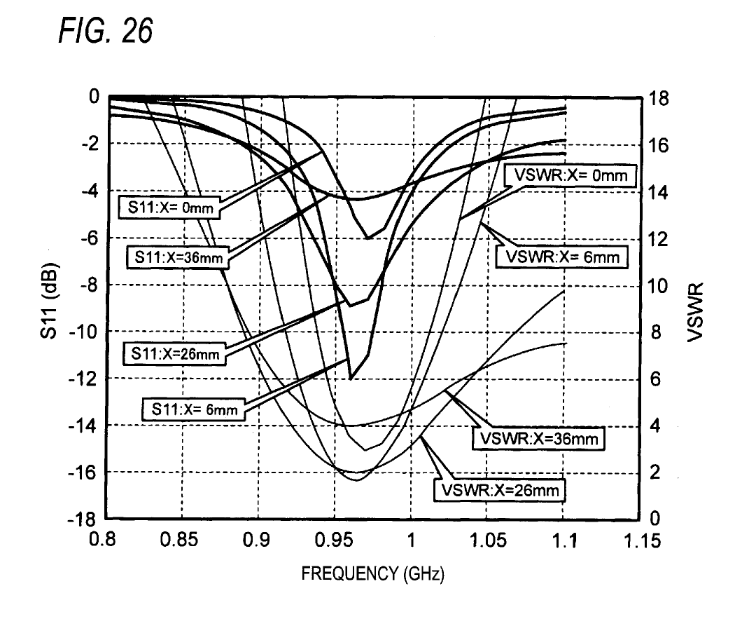

FIG. 26 shows analysis results. The minimum value of the S11 parameter is decreased as the length X varies from 0 mm to 6 mm, and is increased as the length X varies from 6 mm to 26 mm and then to 36 mm. The resonance bandwidth of the S11 parameter is increased as the length X increases. The resonance bandwidth of the VSWR is increased as the length X increases. The resonance bandwidth is increased particularly on the high frequency side as the length X varies from 6 mm to 26 mm and then to 36 mm.

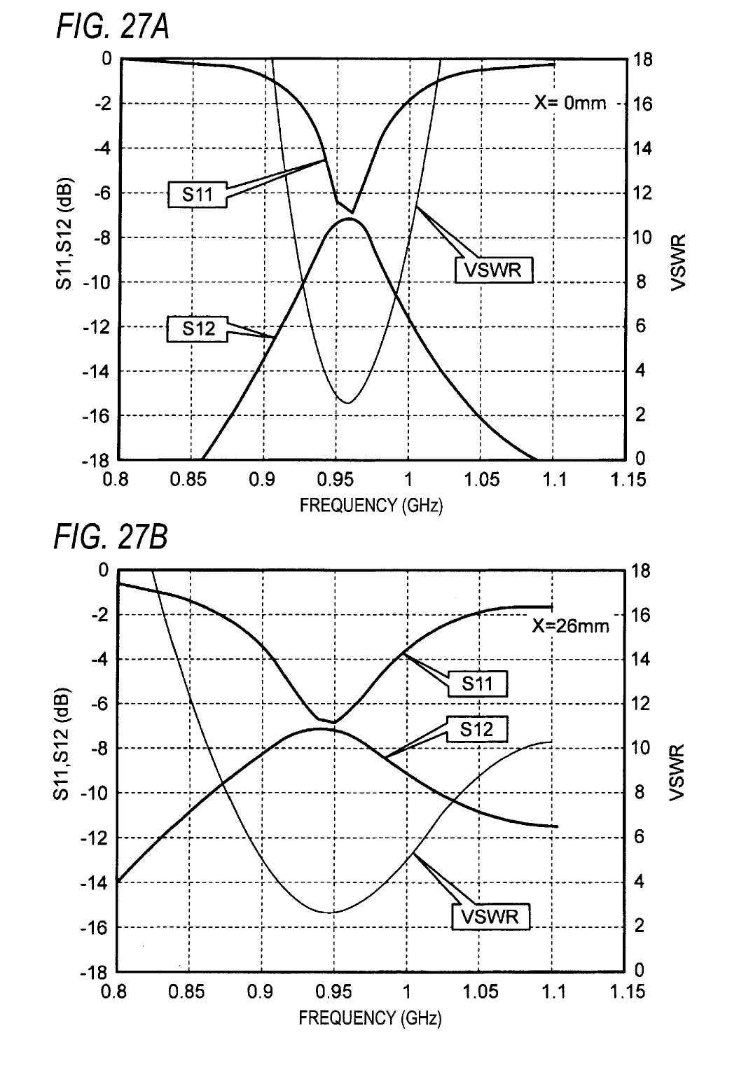

To analyze the performance of communication between the antenna unit of the above analysis model and a reader/writer, values of the S12 parameter, the S12 parameter, and the VSWR were calculated under a condition that the antenna unit of the above analysis model and a wideband antenna (not shown) were opposed to each other with a distance 120 mm. FIGS. 27A and 27B show calculation results. It is seen that the resonance bandwidths of the S11 parameter, the S12 parameter, and the VSWR obtained when the length X is equal to 26 mm are greater than those obtained when length X is equal to 0 mm. It is concluded from the above analysis results that an optimum range of the length X is 26 mm to 36 mm.

(Analysis 6: Dependence on Shape of End Portion, Coextending with Approximately Four Sides of One-Turn Loop Antenna, of Booster Antenna)

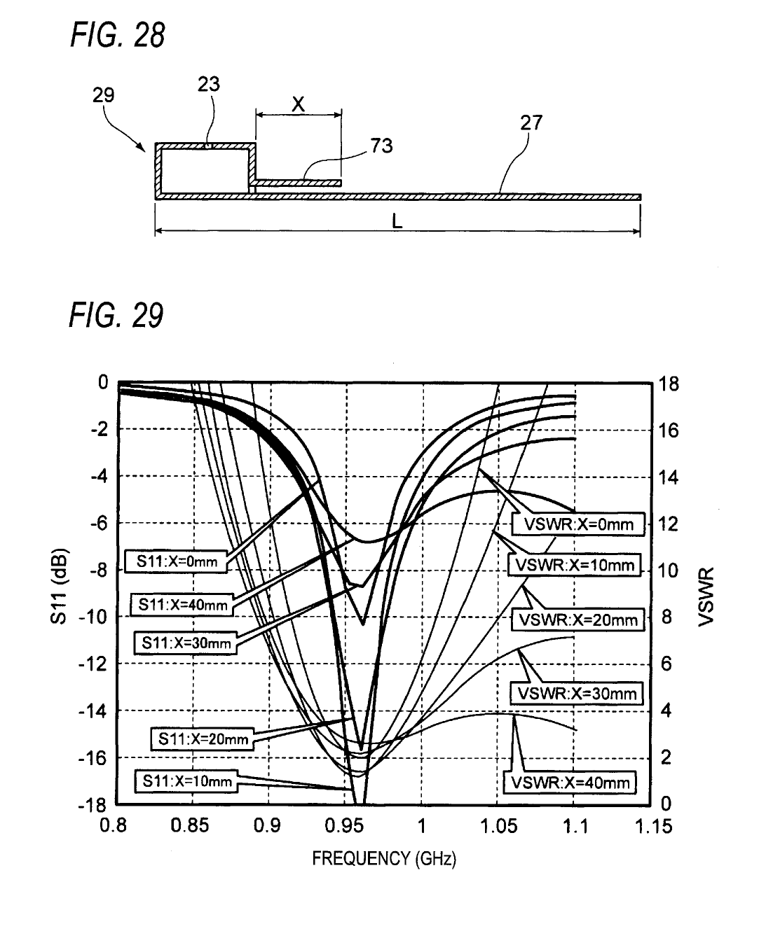

FIG. 28 shows an analysis model in which the length of a projection 73, projecting from a loop antenna 25, of a fold-back portion 29 of a booster antenna 27 is varied. In this analysis, the overall length L, in the longitudinal direction, of the booster antenna 27 was set in a range of 110 mm to 114 mm and the length X of the projection 73 was set at 0 mm, 10 mm, 30 mm, and 40 mm.

FIG. 29 shows analysis results. The minimum value of the S11 parameter is decreased as the length X varies from 0 mm to 10 mm, and is increased as the length X becomes 10 mm, 20 mm, 30 mm, and 40 mm in this order. The resonance bandwidth of the S11 parameter is increased as the length X increases. The resonance bandwidth of the VSWR is increased as the length X increases. The resonance bandwidth is increased particularly on the high frequency side as the length X becomes 10 mm, 20 mm, 30 mm, and 40 mm in this order.

The performance of communication between the antenna unit of the above analysis model and a reader/writer was analyzed.

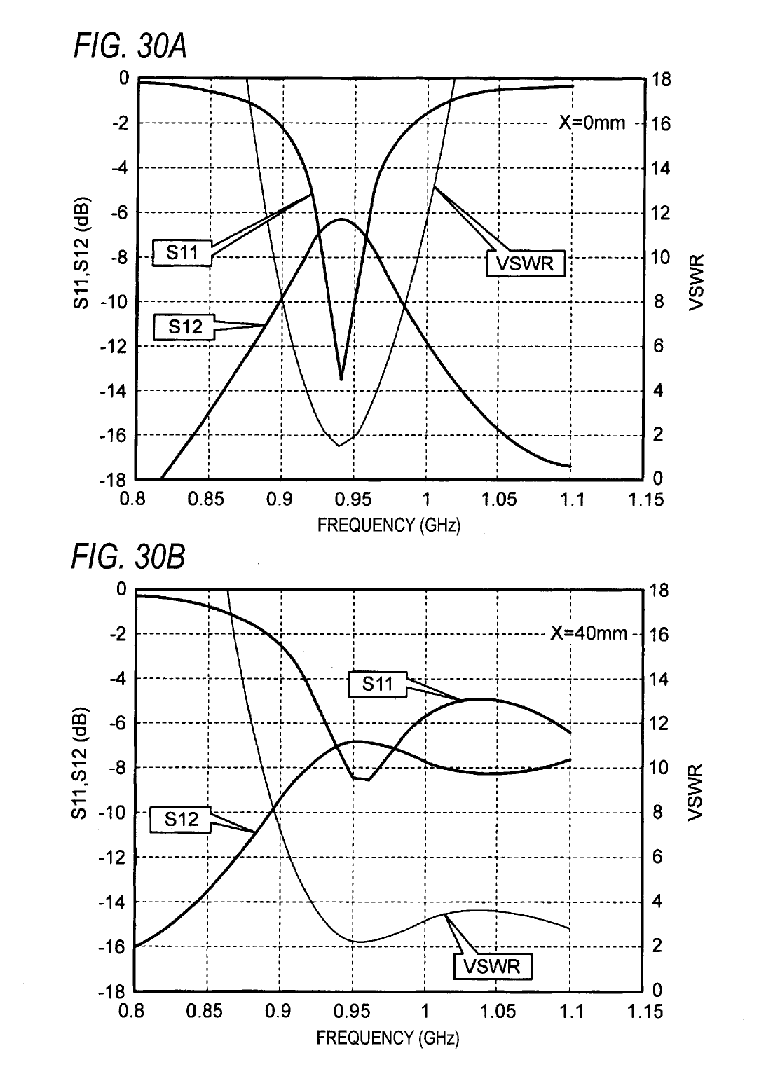

FIGS. 30A and 30B show analysis results. It is seen that the resonance bandwidths of the S11 parameter, the S12 parameter, and the VSWR obtained when the length X is equal to 40 mm are greater than those obtained when length X is equal to 0 mm. The bandwidth increase of each parameter is remarkable on the high frequency side. It is concluded from the above analysis results that an optimum range of the length X is 30 mm to 40 mm.

### (Analysis 7: Differences in Performance Between One-Turn Loop Antenna Itself and Combination of One-Turn Loop Antenna and Booster Antenna)

Because of its simplest configuration, it is difficult to attain matching between a one-turn loop antenna and an IC chip on the market. The resonance frequency of a one-turn loop antenna is determined by a combination of a capacitance component (C) of the IC chip and an inductance component (L) of the one-turn loop antenna. The inductance component the one-turn loop antenna mainly depends on the loop size, and a loop size is determined by an inductance component that conforms to a resonance frequency. However, in this state, the resistance component of the one-turn loop antenna is smaller than that of the IC chip and the VSWR is larger than 100, as a result of which matching is not attained.

On the other hand, if a one-turn loop antenna and a booster antenna are arranged so as to satisfy proper conditions, the booster antenna serves as a resistance component of the one-turn loop antenna. As a result, a combination of an IC chip and the unit consisting of the one-turn loop antenna and the booster antenna satisfies an impedance matching condition.

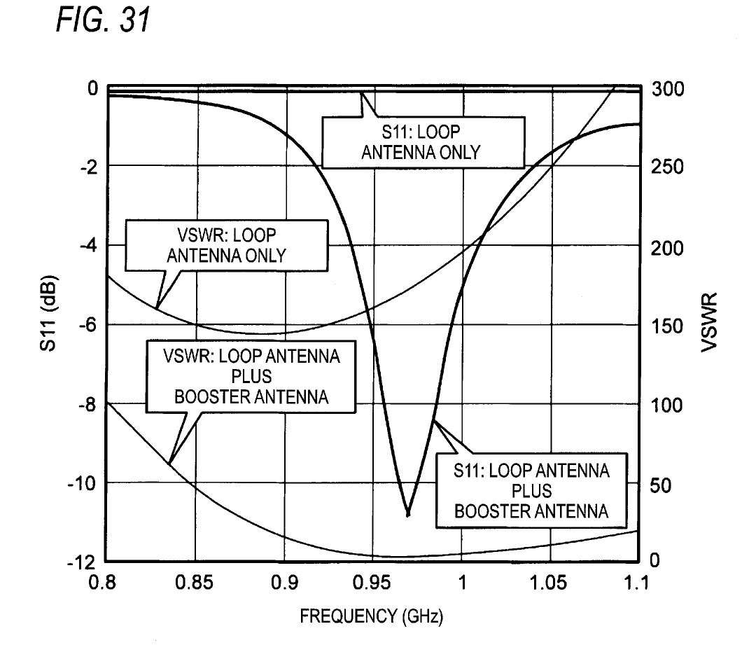

FIG. 31 shows calculation results of the S11 parameter and the VSWR of each of a one-turn loop antenna itself and a combination of a one-turn loop antenna and a booster antenna. Whereas the VSWR of the one-turn loop antenna itself is equal to about 140, the VSWR of the combination of the one-turn loop antenna and the booster antenna is smaller than 2 (see FIG. 18 (X=54 mm).

The invention is not limited to the individual embodiments, and elements of different embodiments can be combined together. A person skilled in the art may be able to make modifications or applications on the basis of the disclosure of the specification and known techniques, and such modifications and applications should be covered by the scope to be protected.

As described above, the following features are disclosed in the specification:

(1) An RF-ID tag comprising an IC, a loop antenna to which the IC is connected, and a linear booster antenna which may be long and narrow as a whole, wherein:

the booster antenna has, as one end portion in its longitudinal direction, a fold-back portion which is wound; and

a portion, having a length that measures 73% or more of a one-turn overall length of a loop of the loop antenna, of the loop antenna extends along a portion, including the fold-back portion, of the booster antenna.

(2) The RF-ID tag of item (1), wherein the loop antenna is laid on the fold-back portion of the booster antenna with a dielectric layer interposed in between.

(3) The RF-ID tag of item (1) or (2), wherein the loop of the loop antenna has a circular or polygonal shape.

(4) The RF-ID tag of item (3), wherein the fold-back portion of the booster antenna is wound in circular or polygonal form.

(5) The RF-ID tag of any one of items (1) to (4), wherein the fold-back portion of the booster antenna is wound in rectangular form and at least three of four wound sides of the fold-back portion extend along sides of the loop antenna.

(6) The RF-ID tag of any one of items (1) to (5), wherein the IC is disposed on the loop antenna at one end, in the longitudinal direction, of the booster antenna.

(7) The RF-ID tag of any one of items (1) to (6), wherein the booster antenna is symmetrical with respect to a line that passes through a center, in the longitudinal direction, of the booster antenna and is perpendicular to the longitudinal direction.

(8) The RF-ID tag of any one of items (1) to (7), wherein at least part of the fold-back portion of the booster antenna coextends with an inside portion that is located inside the loop of the loop antenna.

(9) The RF-ID tag of any one of items (1) to (8), wherein the fold-back portion of the booster antenna is disposed in a region between one end, in the longitudinal direction, of the booster antenna and a position that is distant from the one end by ⅙ of a wavelength used.

(10) The RF-ID tag of any one of items (1) to (9), wherein an insertion loss represented by an S11 parameter is smaller than or equal to −3 dB and a voltage standing wave ratio (VSWR) is smaller than or equal to 6.

(11) The RF-ID tag of item (10), wherein each of the loop antenna and the booster antenna has a resonance frequency in a range of 850 MHz to 1 GHz.

(12) The RF-ID tag of any one of items (1) to (11), wherein a portion, excluding the one end portion in the longitudinal direction, of the booster antenna has a meandering shape.

(13) An RF-ID communication system comprising:

the RF-ID tag of any one of items (1) to (12); and

a reader or a reader/writer which performs a wireless communication with the RF-ID tag.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. An RF-ID tag comprising an IC, a loop antenna to which the IC is connected, and a linear booster antenna, wherein:
the booster antenna has, as one end portion in a longitudinal direction of the linear booster antenna, a fold-back portion which is wound; and
a portion, having a length that measures 73% or more of a one-turn overall length of a loop of the loop antenna, of the loop antenna extends along a portion, including the fold-back portion, of the booster antenna.

2. The RF-ID tag according to claim 1, wherein the loop antenna is laid on the fold-back portion of the booster antenna with a dielectric layer interposed in between.

3. The RF-ID tag according to claim 1, wherein the loop of the loop antenna has a circular or polygonal shape.

4. The RF-ID tag according to claim 3, wherein the fold-back portion of the booster antenna is wound in circular or polygonal form.

5. The RF-ID tag according to claim 1, wherein the fold-back portion of the booster antenna is wound in rectangular form and at least three of four wound sides of the fold-back portion extend along sides of the loop antenna.

6. The RF-ID tag according to claim 1, wherein the IC is disposed on the loop antenna at one end, in the longitudinal direction, of the booster antenna.

7. The RF-ID tag according to claim 1, wherein the booster antenna is symmetrical with respect to a line that passes through a center, in the longitudinal direction, of the booster antenna and is perpendicular to the longitudinal direction.

8. The RF-ID tag according to claim 1, wherein at least part of the fold-back portion of the booster antenna coextends with an inside portion that is located inside the loop of the loop antenna.

9. The RF-ID tag according to claim 1, wherein the fold-back portion of the booster antenna is disposed in a region between one end, in the longitudinal direction, of the booster antenna and a position that is distant from the one end by ⅙ of a wavelength used.

10. The RF-ID tag according to claim 1, wherein an insertion loss represented by an S11 parameter is smaller than or equal to −3 dB and a voltage standing wave ratio is smaller than or equal to 6.

11. The RF-ID tag according to claim 10, wherein each of the loop antenna and the booster antenna has a resonance frequency in a range of 850 MHz to 1 GHz.

12. The RF-ID tag according to claim 1, wherein a portion, excluding the one end portion in the longitudinal direction, of the booster antenna has a meandering shape.

13. An RF-ID communication system comprising:
the RF-ID tag according to claim 1; and
a reader or a reader/writer which performs a wireless communication with the RF-ID tag.
